(19) United States
(12) Patent Application Publication
(10) Pub. No.: US 2019/0149012 A1
(43) Pub. Date: May 16, 2019

(54) DIRECT-DRIVE ELECTRIC MOTOR ARRANGEMENT

(71) Applicant: Fisher & Paykel Appliances Limited, Auckland (NZ)

(72) Inventor: Russell Joseph Jackson, Auckland (NZ)

(21) Appl. No.: 16/308,763

(22) PCT Filed: Jun. 12, 2017
(86) PCT No.: PCT/NZ2017/050076

§ 371 Date: Dec. 10, 2018

(30) Foreign Application Priority Data
Jun. 10, 2016 (NZ) 721096

(51) Int. Cl. H02K 5/173; D06F 37/30; H02K 7/14

(52) U.S. Cl. CPC H02K 5/1737; H02K 5/08; H02K 7/14; D06F 37/304

(57) ABSTRACT

An electric motor assembly (16) that can be pre-assembled, ready for installation in a home appliance such as a laundry washing machine (70). The motor assembly contains two axially-spaced rolling bearings (6, 9), separated by a rotor (12) hub of the electric motor, and a stator (11). An outer housing of the assembly is provided by two oppositely-di shed bearing supports (5, 8) that are connected together at their peripheries to enclose a central space, each of the bearings mounted to a respective one of the bearing supports. The central openings of the bearings and the rotor hub are co-axially aligned and supported in position so that the motor assembly may be fitted over the end of a drum shaft (4) of the laundry machine with the drum shaft in direct contact with at least one of the bearings and the rotor hub non-rotationally engaged with the shaft.

### TECHNICAL FIELD

The present invention relates to a direct-drive electric motor arrangement suitable for providing rotational motion to the drum (also known as the spin tub) of a front-loading (or “horizontal-axis”) or top-loading (or “vertical-axis”) laundry washing machine. In particular, though not solely, the invention relates to a direct-drive motor arrangement that is capable of being formed as a unitary motor assembly capable of separate manufacture from the remainder of the laundry washing machine and of being integrated as a single unit with the remainder of the laundry washing machine during its manufacture.

### BACKGROUND ART

A direct-drive electric motor arrangement is one where the motor directly drives a shaft without a belt or other form of motion transmission device between the rotor and shaft, usually with the rotor fixed about the shaft and rotationally locked thereto. A front-loading laundry washing machine incorporating an inner-rotor type direct-drive electric motor arrangement capable of being pre-assembled as a unit deliverable to a laundry washing machine manufacturing plant is disclosed in U.S. Pat. No. 5,809,809A. In that direct-drive motor arrangement a housing made up of two shell parts contains the stator and rotor and has a shaft protruding therefrom. Within the housing a rotor hub is mounted to the shaft with the hub radially located between the shaft and the respective inner races of first and second axially-separated rolling bearings. Such an arrangement requires that the inner diameter of the rolling bearings must be enlarged beyond the diameter of the shaft alone, thereby increasing their cost. Also, because the rotor hub is between the shaft and the rolling bearings, it must be made from a material capable of resisting radially-directed forces between the shaft and bearings so that the size of the air gap (the annular space between rotor and stator that must be crossed by the magnetic flux generated by the stator) may be maintained at a constant distance. Such a material will of course be relatively expensive compared to cheaper materials from which modern motor structural components are being manufactured, such as plastics. Moreover, because the stator is external to the rotor, compared to an external rotor motor of the same overall size the diameter of the air gap (at which rotor torque is generated) is reduced so inefficiently uses the active motor materials.

A similar direct-drive electric motor arrangement is disclosed in U.S. Pat. No. 8,616,029B although an external-rotor motor is utilised. This arrangement is mounted to a polymeric outer tub of a laundry washing machine. The base of the polymeric outer tub has a central hole in which a first metal hub is insert-moulded while a disc-shaped plastic support part is friction welded at its periphery to the outer surface of the base with the motor located in the space between the base and support part. A second metal hub is insert-moulded in a central opening of the support part with each metal hub providing a seat for the outer race of a respective one of a pair of axially-spaced rolling bearings. The inner races of the bearings are directly mounted to the outer surface of the shaft. The stator of the motor is mounted to the support part while a rotor hub is keyed to the shaft, between the two bearings. Assembly of the motor in the laundry washing machine requires that the drum, with protruding shaft carrying a first bearing, is inserted into the outer tub so that the first bearing is seated in the first metal hub within the tub base. The rotor is then attached to the shaft end protruding from the base of the outer tub. The plastic support part which carries the stator and has a second bearing seated in its second metal hub is then assembled to the end of the shaft and the periphery of the support part frictionally welded to the outside of the base of the outer tub. Clearly, in contrast to the arrangement described in the above U.S. Pat. No. 5,809,809A, this direct-drive electric motor arrangement is not deliverable as a pre-assembled motor unit to a laundry washing machine manufacturing plant. This complex assembly procedure is time-consuming and can lead to poor alignment and damage to the bearings and motor components. Moreover, structural support for the bearings seated within the base of the tub is dependent on characteristics of the polymeric tub material itself, which due to its relatively low stiffness can create problems of vibration and noise under high speed spin loading.

It would therefore be beneficial to provide a direct-drive motor arrangement which can be incorporated into an appliance such as a laundry washing machine, without risk of impermissible misalignments, in the appliance manufacturing plant. Preferably, such an arrangement would be delivered and incorporated as a single, self-contained or pre-assembled or integrated component/unit/assembly thereby avoiding the need for separate or additional bearing housing or support components that would otherwise require insert-moulding or fastening to the outer tub of the machine. Preferably, the arrangement would incorporate axially-separated rolling bearings with a rotor (or at least the rotor's hub) and stator located axially completely or substantially completely between the two rolling bearings.

It is therefore an object of the present invention to provide a direct-drive electric motor assembly suitable for use in a laundry washing machine, which goes at least some way towards meeting the above desiderata or which will at least provide the public or industry with a useful choice.

### SUMMARY OF INVENTION

In a first aspect, the invention consists in a direct-drive electric motor assembly for mounting to a shaft, the assembly comprising:
a pair of spaced apart co-axially-aligned bearings, each bearing including annular inner and outer races,
first and second bearing supports, in each of which an outer race of one of the bearings is positioned, the first and second bearing supports connected together,
a rotor including a rotor hub having a shaft-receiving opening therethrough, the rotor hub co-axially aligned with, and located axially between, the pair of bearings, and
a stator rotationally fixed to one of the bearing supports,
wherein the inner race of at least one of the bearings has an opening commensurate in diameter with an inner diameter of the shaft-receiving opening of the rotor hub.

In a second aspect, the invention consists in a direct-drive electric motor assembly for mounting to a shaft, the assembly comprising:
a pair of spaced apart co-axially-aligned bearings, each bearing including annular inner and outer races,
first and second bearing supports, in each of which an outer race of one of the bearings is positioned, the first and second bearing supports connected together,
a rotor including a rotor hub having a shaft-receiving opening therethrough, the rotor hub co-axially aligned with, and located axially between, the pair of bearings,
a cylindrical sleeve located within the inner race of a first one of the pair of bearings, and
a stator rotationally fixed to one of the bearing supports,
wherein the cylindrical sleeve has an opening commensurate in diameter with the inner diameter of the shaft-receiving opening of the rotor hub.

Preferably, the rotor hub has axially-separated ends with an axially-directed projection protruding from at least one of the ends towards the adjacently-positioned bearing, the axially-directed projection engaging with a surface of the inner race of the adjacently-positioned bearing to thereby limit relative radial movement between the bearing and the rotor hub.

Preferably, the axially-directed projection from an end surface of the rotor hub is an annular projection.

Preferably, the axially-directed projection includes a radially inner surface that engages with a radially outer surface of an inner race of a bearing.

Preferably, the axially-directed projection includes a radially outer surface that engages with a radially inner surface of an inner race of a bearing.

Preferably, the axially-directed projection has a radially inner surface that is tapered radially so that the distal end thereof is further away from the axis than the proximal end thereof.

Preferably, the rotor hub is made from a polymeric material.

Preferably, the rotor hub is a part of a rotor frame that extends radially outwardly from the hub and provides support for a plurality of circumferentially-arranged magnet elements, wherein the rotor frame is a single component made from a single material.

Preferably, a seal is mounted to one of the bearing supports, the seal located axially outside the pair of bearings and extending radially inwardly from said bearing support to provide an inwardly-directed annular sealing surface having a diameter substantially commensurate in diameter with or slightly larger than the inner diameter of the inner race of the bearing positioned within said bearing support.

Preferably, the first and second bearing supports extend radially outwardly from their respective bearing and are connected together at a radial distance from the axis that is greater than the outer diameter of the rotor.

In a third aspect, the invention consists in a laundry appliance including the direct-drive electric motor assembly in accordance with the first or second aspects.

Preferably, the laundry appliance further comprises a rotatable drum incorporating a drum shaft protruding axially therefrom, the direct-drive electric motor assembly mounted over the drum shaft with the inner races of the bearings in direct contact with the outer surface of the drum shaft and the rotor hub rotationally engaged with the shaft.

Preferably, the laundry appliance is a laundry washing machine and further includes an outer tub, the inside of which extends circumferentially about the drum's outer surface and axially over at least part of the drum's outer surface, the outer tub including a base having an opening through which the drum shaft protrudes, the motor assembly fastened to the outer side of the base at the same location that the first and second bearing supports are connected together.

The invention consists in the foregoing and also envisages constructions of which the following gives examples only. In particular, the invention will mainly be described with reference to its incorporation within a front-loading laundry washing machine but those of ordinary skill in the art will appreciate that the invention may be more broadly applied. For example, the invention may be incorporated in other home appliances such as laundry appliances including laundry driers or washer-driers which are conventionally front-loading. The invention could also be incorporated, for example, in a top-loading or “vertical axis” laundry washing machine. The invention will also be described with reference to an outer-rotor-type motor although an internal-rotor motor could alternatively be used.

### BRIEF DESCRIPTION OF DRAWINGS

Preferred forms of the invention will now be described with reference to the accompanying drawings, in which:

FIG. 1 is an exploded perspective view of drum and tub components of a front-loading laundry washing machine including a direct-drive electric motor assembly in accordance with a preferred form of the present invention,

FIG. 2 is a cross-sectional view through the assembled drum and tub assembly of FIG. 1, including a direct-drive electric motor arrangement according to a first preferred embodiment of the present invention,

FIG. 3 is a cross-sectional view through the assembled drum and tub assembly of FIG. 1, including a direct-drive electric motor arrangement according to a second preferred embodiment of the present invention,

FIG. 4 is an exploded perspective view of drum and tub components of a front-loading laundry washing machine including a direct-drive electric motor assembly in accordance with a third preferred embodiment of the present invention,

FIG. 5 is a cross-sectional view through the motor assembly of FIG. 4,

FIG. 6 is a cross-sectional view through the assembled drum and tub assembly of FIG. 4, and

FIG. 7 is a perspective view of a front-loading laundry washing machine incorporating the direct-drive electric motor assembly according to any of the preferred embodiments.

### DESCRIPTION OF EMBODIMENTS

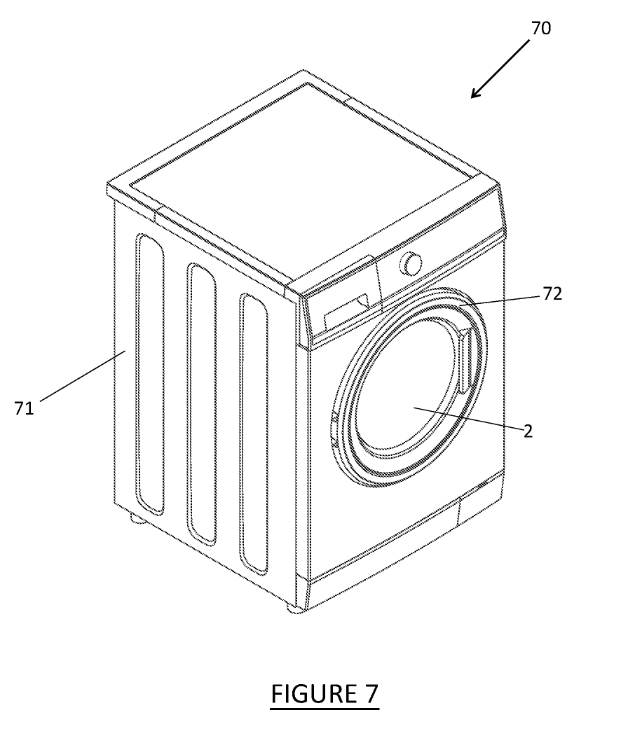

A laundry clothes washing machine 70 such as that shown in FIG. 7, as is well known, includes an outer cabinet or “wrapper” 71 which contains a generally cylindrical, fixed (non-rotating) outer tub (hidden from views) for containing washing liquid and within which is provided a generally cylindrical rotatable perforated drum 2 for holding a load of laundry such as clothing for washing. Access to the drum is via a door 72 mounted to cabinet 70. The outer tub may be formed from a plastics material and, in the case of a front-loading laundry washing machine, the outer tub may be formed in two axially separate halves which are subsequently sealed together about the drum.

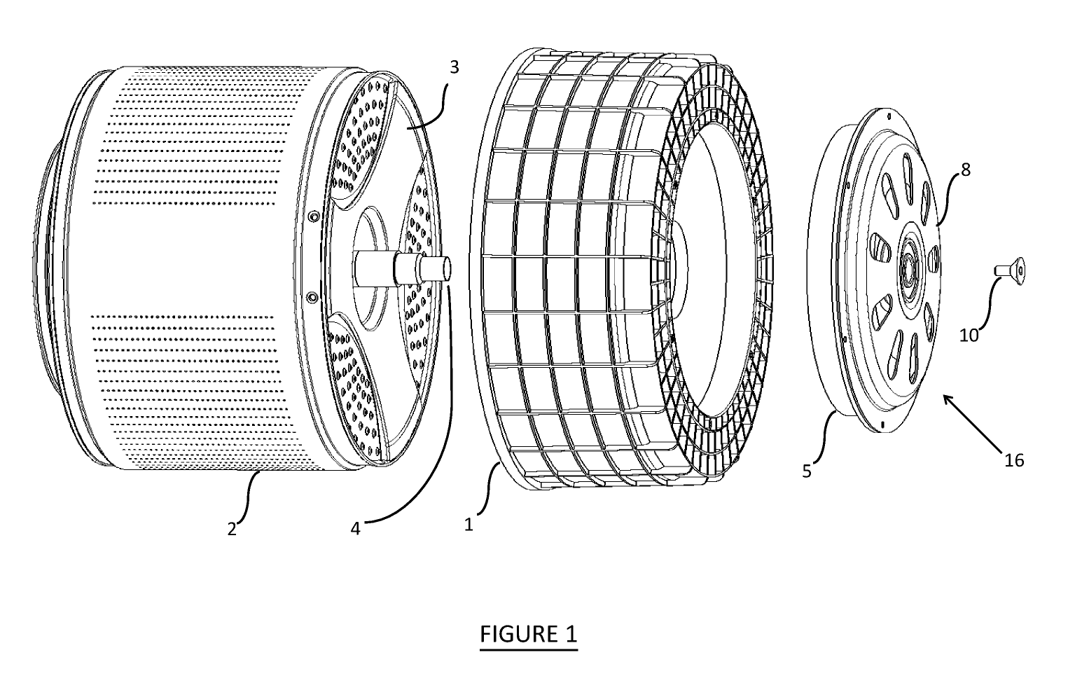

In the exemplary illustration of FIG. 1, one half 1 (the rear half) of the tub is shown between drum 2 and a pre-assembled motor arrangement or assembly 16 according to a preferred form of the present invention. The drum 2 includes a supporting structure such as casting 3 from which a shaft 4 (for example, a steel shaft) fixedly protrudes and which is adapted to pass through a central opening in tub half 1 for connection to the motor assembly 16. Casting 3 may, for example, be formed as shown with three radially-extending spokes spanning between the periphery of the drum and the shaft.

Assembly of the appliance 70 at the appliance manufacturer's plant could include the step of inserting the drum into the tub half 1, followed by mounting of the motor assembly 16 upon shaft 4 on the outer side of the tub's end face or base. Alternatively, the assembly process could include mounting the motor assembly 16 to the outer side of the base of the outer tub half 1 and then inserting drum 2 into tub half 1 so that shaft 4 extends through the hole in the tub base and then into motor assembly 16. The motor assembly 16 is fixed to the shaft by bolt 10. A second, front half (not shown) of the outer tub, similar to but a mirror image of tub half 1 but with a larger access hole in its end face to allow access to drum 2 via door 72, would then be axially assembled over drum 2 so that the peripheral edges of the two tub halves are in contact and may be locked together with a water-tight seal therebetween. In an alternative embodiment, shaft 4 could be formed with motor assembly 16 and connected to casting 3 of drum 2 when the shaft is inserted through tub half 1.

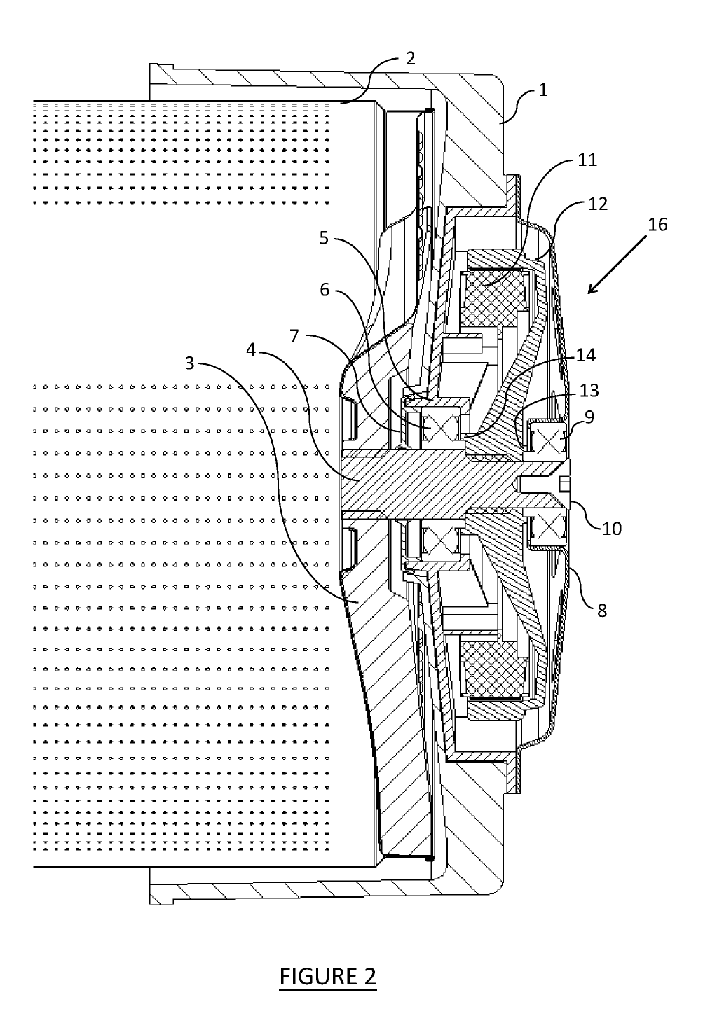

As shown in FIG. 2, a pair of (preferably a single pair of; that is two) axially-spaced bearings 6, 9 rotatably support shaft 4. Preferably the bearings are each rolling (or “rolling element”) bearings with annular, co-axially-aligned inner and outer races separated by rolling elements such as ball bearings or rollers enabling independent rotation of the inner and outer races about their common axis. An outer or first bearing 9 is provided at or near the end of shaft 4 with bolt 10 tightenable in an axial hole at the shaft end. The underside of the head of bolt 10 being frusto-conically-shaped to match the profile of the outer end of the hole in order to radially clamp the drum shaft 4 to the first bearing's inner race as the bolt is tightened. Bolt 10 may have a head outer diameter larger than the inner diameter of the inner race of outer bearing 9 so that the outer bearing is axially retained on the shaft by bolt 10. Bearings 6, 9 are located in the motor assembly 16 by respective first 8 and second 5 bearing housings or bearing supports. A seal 7 mounts to second bearing housing 5 and extends radially inwardly therefrom to shaft 4 to provide a rotational seal to the drum shaft 4 and a static seal to the tub 1 base. The bearing housings may be formed from pressed sheet metal, such as pressed sheet steel. To increase the stiffness of the motor assembly the second bearing housing could be formed from a stronger material such as a cast metal (e.g., cast steel) or it could be formed by injection-moulding a sufficiently strong engineering plastics material.

It will be appreciated from FIGS. 1 and 2 that the first 8 and second 5 bearing housings are generally oppositely dished circular or plate-like structures including bearing-outer-race-seating features for locating and holding in place one of bearings 6, 9. Bearing housings 5, 8 extend radially outwardly substantially to or beyond a generally cylindrical periphery of the motor assembly from their respective bearings and, when connected, enclose a volume in which the motor components are contained. In the embodiments illustrated in the drawings the first bearing housing 8 and the second bearing housing 5 are fixed together, in such a manner as to substantially fix the relative positions of the bearing seating features, radially outwardly of the rotor's outer diameter and fasteners (not shown) may lock the first 8 and second 5 bearing housings together. The fasteners may also fix the motor assembly's outer casing (bearing housings 5, 8) to the outer surface of the base of half tub 1, for example by insertion through mating, radially-projecting outer peripheral flanges, as shown in the drawings. The end face of tub half 1 has a central cavity commensurate in shape and diameter so as to receive the motor assembly, in particular the generally cylindrical periphery formed by bearing housing 5.

As shown in FIG. 1, the outer bearing housing 8 may be provided with cooling openings or at least one of the bearing supports may be provided with cooling fins (not shown) for increasing the heat-radiating surface area of the motor assembly 16. Also, instead of simple openings as shown in FIG. 1, louvre openings may be provided to a bearing housing whereby the opening is partially surrounded/covered by a hood out of the plane of the opening and which may provide a benefit in audible noise reduction. Aligning the louvres so that air tends to be sucked in rather than blown out of the motor assembly when the rotor is running in the spin (laundry load-dehydrating) direction may increase the baffling effect when rotating at high speed.

A stator 11 of the motor assembly is fastened to one of the bearing housings, for example, as shown in FIG. 2, the stator may be mounted to the second bearing housing 5. As is well-known, the stator may be formed as a stack of thin, generally circular steel laminations (or a single helically-wound lamination), the lamination(s) having pole cores extending radially (radially outwardly for an outer rotor-type motor) from an annular base section, and stator windings wound upon the stacked pole cores. The stator core may be over-moulded by a plastics frame having an inwardly-projecting substantially flat-, curved- or frusto-conical-disc shaped mounting section radially inside the stack having a central opening through which the shaft may pass (see our publication WO2012087156A for examples of suitable plastics stator frames).

Preferably the stator mounting arrangement maximises concentricity between the stator and the bearings. In an exemplary stator mounting arrangement, it would be beneficial to locate a part of the stator against (that is, in physical contact with) a surface of a bearing housing which is also locating a bearing. If not in direct physical contact with the bearing-locating surface of the bearing housing, a part of the stator would ideally be in contact with a surface of the bearing housing that is as closely concentric with the bearing-locating surface as possible. This could be achieved, for example, by curving the disc-shaped section of the stator frame as it transitions towards the axis from a generally radial direction toward a generally axial direction to thereby provide a stator-locating lip about the opening. The surface of the bearing housing, for example housing 5, which is radially outside and in contact with the outer race of bearing 6 may be extended substantially axially a short distance toward bearing 9 to provide an annular locating sleeve having an inner diameter commensurate in diameter with the annular stator-locating lip of the stator frame. The stator-locating lip of the stator frame may be positioned inside and in contact with the annular locating sleeve of the bearing housing with additional fastening means such as screws or bolts provided between the mounting section of the stator frame and the bearing housing to avoid relative rotation therebetween.

It will be appreciated that the direct-drive motor assembly 16 includes at least the motor rotor 12, motor stator 11, pair of bearings 6, 9 and bearing housings 5, 8. Although the preferred embodiment illustrated in FIG. 2 includes an electronically-commutated external rotor motor, other types of motor, including internal-rotor motors, could alternatively be incorporated in the motor assembly. In an internal-rotor version of the direct-drive motor assembly 16, the bearing housings could be connected together radially outwardly of the rotor's outer diameter but radially inwardly of the stator's outer diameter.

As is well known, in one preferred form, the rotor of the illustrated external-rotor motor may carry a plurality of magnet elements arranged on an inner side of an outer circumferential surface of the rotor so that their exposed surfaces face radially outwardly-projecting electronically-commutated poles of stator 11 with an annular air gap between the tips of the stator poles and the opposing magnets. The rotor may include a rotor frame incorporating a central rotor hub adapted for mounting to the shaft and extending radially outwardly therefrom to provide support for the magnet elements. The rotor frame may be formed as a single component from a single material such as a polymeric material or a metal such as steel. Alternatively, the hub may be formed from a first material such as steel or another metal, over-moulded by the remainder of the frame which may comprise a plastics material. As a further alternative, the hub could be formed from a plastics material with the remainder of the frame formed from a metal such as steel.

Rotor 12 is rotationally fixed to the drum shaft 4 by its hub at a position axially between the first bearing 9 and the second bearing 6. As shown in FIG. 2, complementary, engaging tooth, key or spline features may be provided on both the drum shaft 4 and the internal surface of the rotor hub to transmit driving torque from the rotor 12 to drum shaft 4 and drum 2. The tooth features may have any cross-sectional profile suitable for avoiding relative rotation between the interlocking parts, such as generally triangular or square/rectangular. Preferably the interlocking complementary features on the rotor hub and drum shaft are an interference or zero clearance fit whereby engagement of the complementary tooth features may also axially fix the location of the rotor relative to the shaft. It may also be seen that the outer end of shaft 4 has a smaller diameter substantially cylindrical surface than the diameter of the substantially cylindrical surface of the drum shaft end nearest the drum, with a shoulder region there-between restricting movement of the hub toward the drum. Preferably the axial distance between the respective inner races of first and second bearings 9, 6 is about the same or slightly greater than the axial distance between the end faces of the rotor hub.

In the situation where drum shaft 4 is fixed to drum 2, such as via tri-spoke casting 3, one or more of the axially-separated end surfaces of the hub of rotor 12 may be provided with an axially-directed projection such as shoulders 13 and 14 for engagement with outer diameters of axial extensions provided on the inner races of respective bearings 6 and 9. The shoulders 13, 14 may be one or more distinct axially-directed projection(s) at a common radial distance from the axis of the hub or may be an annular or substantially cylindrical shoulder extending part-way or completely about the axis. Shoulders 13 and 14 function to rotatably support and locate the rotor prior to insertion of the drum shaft 4, allowing the direct-drive motor assembly 16 to be completely assembled as a unit independent of the tub and drum components. It will be appreciated that such a feature will ensure that the openings in seal 7, bearing 6, the hub of rotor 12 and bearing 9 are co-axially aligned so that the motor assembly 18 may be easily pushed onto shaft 4 after it has passed through the central opening in tub half 1.

Enabling the motor and hub components to be fully assembled as a unit independent of the tub and drum components reduces the likelihood of assembly alignment errors and damage to the motor and hub components. Axially-projecting shoulders 13, 14 on the rotor hub enable the motor (that is, rotor and stator) to be assembled independently of the shaft without the rotor hub having to extend fully into the bearing (as in the aforementioned U.S. Pat. No. 5,809,809A) which would require enlargement of the bearing inner races and increased bearing cost. Additionally, rotor hub shoulders 13, 14 do not prevent the direct support of the drum shaft by the inner races of the first and second bearings when the drum and tub assembly is completed. That is, the direct-drive motor assembly shown in FIG. 2 may be easily assembled to drum shaft 4 while still enabling the inner races of bearings 6, 9 to be in direct contact with the surface of shaft 4 rather than being separated therefrom by a potentially compressible material. This reduces radial or lateral shaft and rotor movement relative to the stator (as in the aforementioned U.S. Pat. No. 8,616,029B).

It will be appreciated that an axial space is required between the bearings to reduce radially-directed bearing loads due to drum imbalances (out-of-balance loads). Axially locating the direct-drive motor (that is, rotor 12—or at least its hub—and stator 11) in the axial space between the two drum shaft bearings 6, 9 efficiently utilises the necessary inter-bearing space in contrast to an arrangement whereby the bearings are both provided on the same side of the motor. In that arrangement, the motor takes up additional space outside of the bearings and rotor hub.

Accordingly, the configuration in accordance with the preferred embodiment of the invention reduces the overall axial length of the drive system enabling a greater drum volume and therefore increased laundry capacity to be achieved for a given overall cabinet depth.

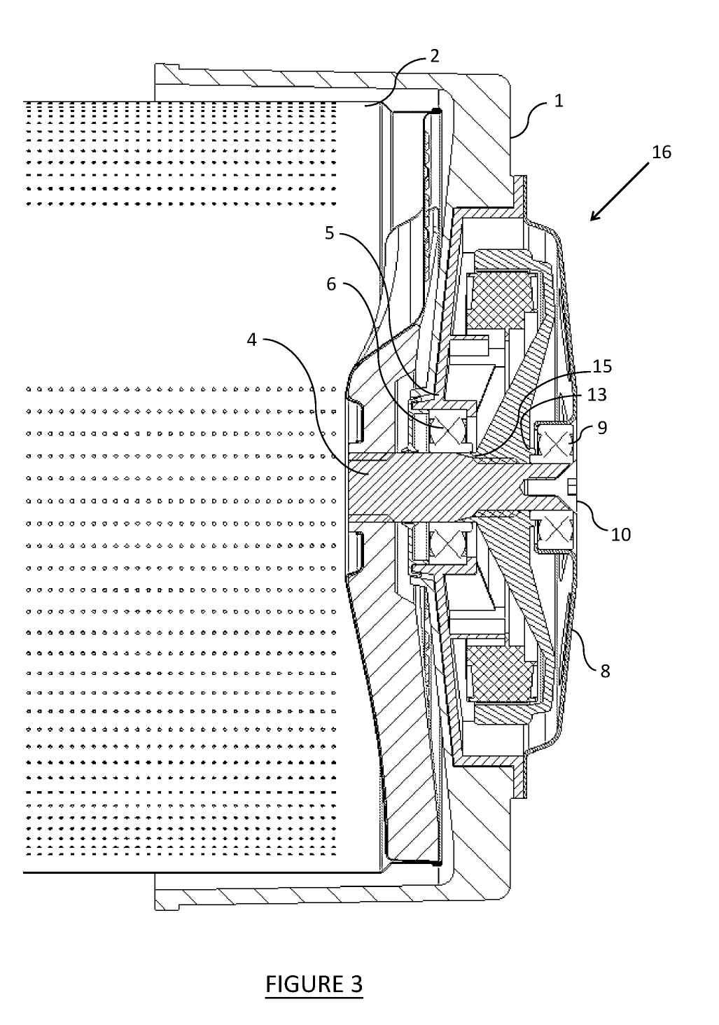

FIG. 3 illustrates a direct-drive motor assembly 16 in accordance with an alternative preferred embodiment of the present invention in which the inner hub shoulder 14 shown in the embodiment of FIG. 2 is substituted with a hub lip 15 extending axially partially inside the inner race of the second bearing 6. The provision of hub lip 15 avoids the need for an extended inner race on the second bearing 6 (although the unnecessary extended inner race of bearing 6 is still shown in FIG. 3) but does not prevent at least some amount of direct support/contact of the drum shaft 4 by/with the second bearing 6 when the drum 2 and drum shaft 4 and tub 1 assembly is completed. As shown in FIG. 3, lip 15 may extend beneath the inner race of bearing 6 less than about 50% of its axial width/extent, preferably between about 20% and about 40% of its axial width/extent. Optionally, as illustrated in FIG. 3, the inner race of outer bearing 9 may retain shoulder 13 to maintain accurate radial alignment of the outer end of the rotor hub in the assembly prior to mounting of the motor assembly to shaft 4 although annular lip 15 may be sufficient for this purpose.

Hub lip 15 may also, as illustrated in FIG. 3, be tapered and engage with a correspondingly tapered circumferential region on the drum shaft 4. Rotor 12, or only the rotor hub including lip 15, may be made of a plastics or polymeric or other semi-compliant material without substantially compromising or reducing the ability of the bearings and bearing supports to resist radial movement of the shaft in response to out-of-balance drum loads. During assembly of the appliance according to this embodiment, following locating of the motor assembly 16 over shaft 4, the tightening of bolt 10 will pull drum shaft 4 into the opening within tapered rotor hub lip 15. This will cause the annular tapered lip (which, as part of rotor 12 is rotationally locked to shaft 4) to expand radially, come into contact with and provide a radially-directed force to the inner race of second bearing 6 thereby ensuring that the inner race of second bearing 6 is rotationally fixed to drum shaft 4. The magnitude of the radially-directed force may be adjusted by varying the tightening torque applied to bolt 10. Improved rotational fixing of the inner race of second bearing 6 and drum shaft 4 together may reduce wear and noise generation otherwise caused by relative movement between these two components.

A further, non-illustrated alternative embodiment of the invention will now be described. This alternative embodiment is similar to the embodiment of FIG. 3 but avoids the need for the inner races of both bearings 6, 9 to have an axial extension (as mentioned above, the inner race of bearing 6 need not include an axial extension although it is illustrated in FIG. 3). By avoiding the requirement for axially-extended inner races it will be possible to utilise standard, and therefore reduced-cost, rolling bearings.

In this embodiment, the axially inner end of the rotor hub (adjacent inner bearing 6) may include a lip feature (either completely annular or semi-annular) similar to that described above in relation to the embodiment of FIG. 3 so that the outer surface of the lip feature is able to provide lateral positional support to the inner end of the rotor in the absence of shaft 4 (that is, prior to installing the motor assembly in the tub and drum assembly at the laundry washing machine manufacturing plant). In this embodiment the axially-outer end of the rotor hub is also similarly-shaped to the FIG. 3 embodiment with axially-directed projecting shoulder 13 providing a stepped axial recess which in the FIG. 3 embodiment is occupied by the inner race extension of bearing 9. In this embodiment however, the stepped recess is occupied by a substantially cylindrical sleeve or collet having an inner diameter commensurate with the inner diameter of the rotor hub. The inner race of outer bearing 9 is seated on the outer surface of the sleeve which may be formed from a substantially incompressible material such as steel. Preferably the outer end of the sleeve has a bevelled edge at its opening which co-operates with a similarly-angled face on bolt 10. The outer periphery of the sleeve may have a radially-outwardly-extending lip adapted to engage with an outer surface of the inner race of bearing 9.

With this arrangement, tightening of bolt 10 axially moves the sleeve into contact with the rotor hub, moving the rotor hub towards inner bearing 6 and wedging the lip feature of the rotor hub beneath the inner race of the inner bearing 6 to help fix inner bearing 6 in its axial position on the shaft. Tightening of bolt 10 may also provide a radially outward force component to the sleeve, via engaging bevelled faces, which may tighten the sleeve to the inner race of outer bearing 9 if the sleeve is formed as an expandable collet, for example.

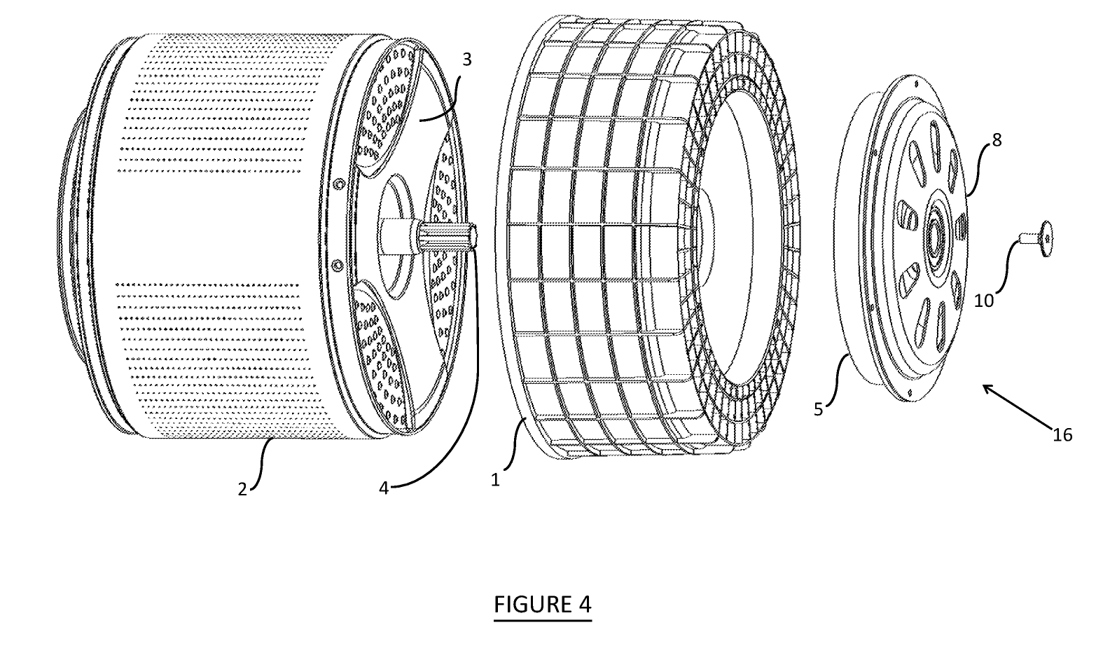

A still further alternative embodiment (the third illustrated embodiment) of the present motor assembly will now be described with reference to FIGS. 4 to 6. This embodiment is similar to the other embodiments although the design of the rotor hub, and the surface of the drum shaft 4 to which it is adapted to engage, are modified to enable regular rolling bearings 6, 9 to be used without the need for an extended inner race on either bearing.

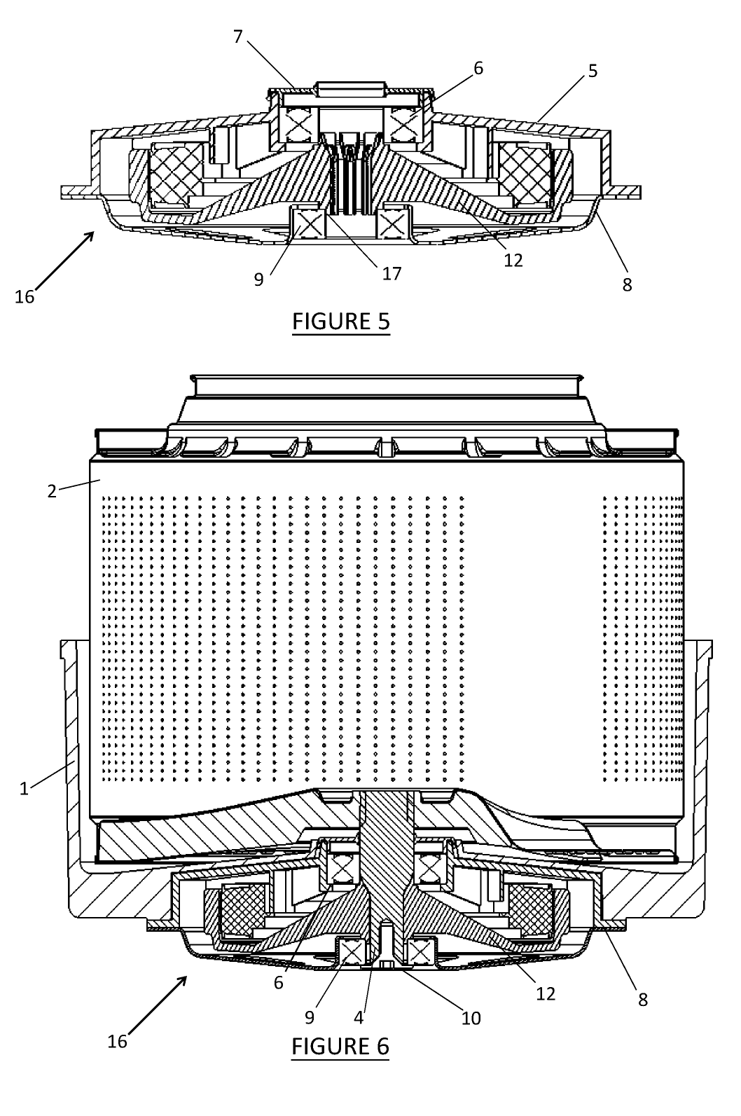

As can be seen in FIG. 6, the axially inner end of the rotor hub, adjacent inner bearing 6, is preferably provided with an axially-extending lip feature similar to that described above in relation to the embodiment of FIG. 3 so that the outer surface of the lip feature is able to provide lateral positional support to the inner end of the rotor in the absence of shaft 4. In contrast to the embodiment illustrated in FIG. 3, the outer axial end of the rotor hub includes at least one axially-directed projection 17 which underlaps the inner race of bearing 9 as may be seen in FIGS. 5 and 6. That is, the axially-directed projection(s) at the outer end of the rotor hub extend beneath the inner race of the outer bearing 9, between the shaft and the bearing inner race, to provide positional support for the rotor hub in the absence of drum shaft 4. The axially-directed projection(s) from the outer end of the rotor hub may extend beneath the inner race of bearing 9 over only a part or all of its axial width.

Preferably, a plurality of axially-directed hub projections 17 are circumferentially spaced about the hub's shaft-receiving opening, the inner surfaces of which define the hub opening's inner diameter. Preferably the axially-directed projections 17 are integrated with (that is, perform the dual function of) tooth features for rotationally interlocking the rotor hub to drum shaft 4. This may be accomplished by forming the tooth features about the inner surface of the rotor hub with a substantially square or rectangular or annular sector-shaped profile (when viewed axially) and extending them axially outwardly from the end of the rotor hub so that they also form the aforementioned axially-extending projections. A complementary square, rectangular or annular sector-shaped tooth profile may be cut out of the outer surface of drum shaft 4 as may be seen in FIG. 4. The outer surface of the teeth cut into the drum shaft's surface preferably lie on a circle having a diameter substantially equal to or slightly larger than the inner diameter of the inner race of bearing 9. The spaces between the radially-extending teeth of drum shaft 4 are shaped to slidingly receive the axially-extending projections of the rotor hub as the motor assembly is mounted to the shaft. Accordingly, the inner diameter of the shaft's tooth profile (that is, the diameter of troughs between radially-outwardly extending teeth) is the same or smaller than the inner diameter of the shaft-receiving opening in the rotor hub. The outer surfaces of the rotor hub's axially-extending projections are preferably on a circle commensurate in diameter with the outer diameter of the shaft's teeth.

In this way, in the absence of the drum shaft, the axially-extending projections 17 form a ring of rotor hub-positioning posts that fit within the inner race of bearing 9 to help locate the rotor in the motor assembly. When the drum shaft is inserted and the complementary teeth features of the rotor hub and shaft are aligned and engaged, the axially-directed projections fill the axial slots between teeth on the outer surface of the drum shaft so that the surface beneath the inner race of bearing 9 is made up of, and may therefore be supported by, a combination of circumferential sections of the drum shaft interspersed with circumferential sections of the rotor hub's axially extending projections (that is, the axial projections of the inner teeth of the rotor hub). Preferably the same number of shaft teeth and hub inner teeth are provided and the meshing of hub to shaft creates a substantially complete cylindrical surface beneath the inner race of the outer bearing. However, it is not essential that the circumferential extent of the rotor hub (inner) teeth is the same as the circumferential extent of the drum shaft (outer) teeth. That is, the angular extent of the circumferential gaps between the radially-outwardly extending drum shaft teeth could be the same as, smaller than or larger than the angular or circumferential extent of the drum shaft teeth. This embodiment may be particularly suited to an entirely polymeric or plastics rotor frame, including the rotor hub, because it enables the shaft to be supported over much or most of its circumference and axial length by direct contact with the inner race of the bearing.

1. A direct-drive electric motor assembly for mounting to a shaft, the assembly comprising:
a pair of spaced apart co-axially-aligned bearings, each bearing including annular inner and outer races,
first and second bearing supports, in each of which an outer race of one of the bearings is positioned, the first and second bearing supports connected together,
a rotor including a rotor hub having a shaft-receiving opening therethrough, the rotor hub co-axially aligned with, and located axially between, the pair of bearings, and
a stator rotationally fixed to one of the bearing supports,
wherein the inner race of at least one of the bearings has an opening commensurate in diameter with a diameter of the shaft-receiving opening of the rotor hub.

2. The direct-drive electric motor assembly as claimed in claim 1, wherein the rotor hub has axially-separated ends with at least one axially-directed projection protruding from at least one of the ends towards the adjacently-positioned bearing, the at least one axially-directed projection engaging with a surface of the inner race of the adjacently-positioned bearing to thereby limit relative radial movement between the bearing and the rotor hub.

3. The direct-drive electric motor assembly as claimed in claim 2, wherein the at least one axially-directed projection from an end surface of the rotor hub is an annular projection.

4. The direct-drive electric motor assembly as claimed in claim 2, wherein the at least one axially-directed projection includes a radially inner surface that engages with a radially outer surface of an inner race of a bearing, or a radially outer surface that engages with a radially inner surface of an inner race of a bearing.

5. (canceled)

6. The direct-drive electric motor assembly as claimed in claim 4, wherein the at least one axially-directed projection has a radially inner surface that is tapered radially so that the distal end thereof is further away from the axis than the proximal end thereof.

7. The direct-drive electric motor assembly as claimed in claim 2, wherein the surface of the shaft-receiving opening in the rotor hub is provided with radially inwardly-directed tooth features circumferentially arranged about the axis, the tooth features extending outwardly of an axial outer end of the rotor hub to form the at least one axially-directed projection.

8. The direct-drive electric motor assembly as claimed in claim 7, wherein the shaft-receiving opening in the rotor hub has a first diameter defined by the tips of the tooth features and a second, larger diameter defined by the bases of the troughs between adjacent teeth, wherein the second diameter is commensurate with the diameter of the opening in the inner race of the bearing adjacent to the at least one axially-directed projection.

9. (canceled)

10. The direct-drive electric motor assembly as claimed in claim 1, wherein the rotor hub is a part of a rotor frame that extends radially outwardly from the hub and provides support for a plurality of circumferentially-arranged magnet elements, wherein the rotor frame is a single component made from a single material.

11. The direct-drive electric motor assembly as claimed in claim 1, wherein a seal is mounted to one of the bearing supports, the seal located axially outside the pair of bearings and extending radially inwardly from said bearing support to provide an inwardly-directed annular sealing surface having a diameter substantially commensurate in diameter with or slightly larger than the inner diameter of the inner race of the bearing positioned within said bearing support.

12. (canceled)

13. A laundry appliance including the direct-drive electric motor assembly as claimed in claim 1.

14. The laundry appliance as claimed in claim 13, further comprising a rotatable drum incorporating a drum shaft protruding axially therefrom, the direct-drive electric motor assembly mounted over the drum shaft with the inner races of the bearings in direct contact with the outer surface of the drum shaft and the rotor hub rotationally engaged with the shaft.

15. The laundry appliance as claimed in claim 14, wherein the laundry appliance is a laundry washing machine and further including an outer tub, the inside of which extends circumferentially about the drum's outer surface and axially over at least part of the drum's outer surface, the outer tub including a base having an opening through which the drum shaft protrudes, the motor assembly fastened to the outer side of the base at the same location that the first and second bearing supports are connected together.

16. A direct-drive electric motor assembly for mounting to a shaft, the assembly comprising:
a pair of spaced apart co-axially-aligned bearings, each bearing including annular inner and outer races,
first and second bearing supports, in each of which an outer race of one of the bearings is positioned, the first and second bearing supports connected together,
a rotor including a rotor hub having a shaft-receiving opening therethrough, the rotor hub co-axially aligned with, and located axially between, the pair of bearings,
a cylindrical sleeve located within the inner race of a first one of the pair of bearings, and
a stator rotationally fixed to one of the bearing supports,
wherein the cylindrical sleeve has an opening commensurate in diameter with the inner diameter of the shaft-receiving opening of the rotor hub.

17. The direct-drive electric motor assembly as claimed in claim 16, wherein the rotor hub has axially-separated ends with at least one axially-directed projection protruding from at least one of the ends towards the adjacently-positioned bearing, the at least one axially-directed projection engaging with a surface of the inner race of the adjacently-positioned bearing to thereby limit relative radial movement between the bearing and the rotor hub.

18. The direct-drive electric motor assembly as claimed in claim 17, wherein the at least one axially-directed projection from an end surface of the rotor hub is an annular projection.

19. The direct-drive electric motor assembly as claimed in claim 17, wherein the at least one axially-directed projection includes a radially inner surface that engages with a radially outer surface of the cylindrical sleeve, or a radially outer surface that engages with a radially inner surface of an inner race of a bearing.

20. (canceled)

21. The direct-drive electric motor assembly as claimed in claim 20, wherein the at least one axially-directed projection has a radially inner surface that is tapered radially so that the distal end thereof is further away from the axis than the proximal end thereof.

22. (canceled)

23. The direct-drive electric motor assembly as claimed in claim 16, wherein the rotor hub is a part of a rotor frame that extends radially outwardly from the hub and provides support for a plurality of circumferentially-arranged magnet elements, wherein the rotor frame is a single component made from a single material.

24. The direct-drive electric motor assembly as claimed in claim 16, wherein a seal is mounted to one of the bearing supports, the seal located axially outside the pair of bearings and extending radially inwardly from said bearing support to provide an inwardly-directed annular sealing surface having a diameter substantially commensurate in diameter with or slightly larger than the inner diameter of the inner race of the bearing positioned within said bearing support.

25. (canceled)

26. A laundry appliance including the direct-drive electric motor assembly as claimed in claim 16.

27. (canceled)

28. (canceled)
